(19) United States
(12) Patent Application Publication
(10) Pub. No.: US 2011/0036958 A1
(43) Pub. Date: Feb. 17, 2011

(54) Portable Laboratory Stand

(75) Inventor: Roger Moore, Brandon, MS (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: SHELDON LABORATORY SYSTEMS, INC., Crystal Springs, MS (US)

(21) Appl. No.: 12/540,552

(22) Filed: Aug. 13, 2009

(51) Int. Cl. F16M 11/22

(52) U.S. Cl. 248/188.1

(57) ABSTRACT

A portable laboratory stand is disclosed for use with laboratory tables having rod sockets. The stand does not consume the rod socket, so that the socket is still available for use with a laboratory rod with the stand in place. The stand can be used to support laptops, books, papers, or small electronic equipment to keep them above surfaces where spills may occur and where the room may be needed for experiment components.

### FIELD OF THE INVENTION

The present invention relates generally to portable stands for use in connection with laboratory tables.

### BACKGROUND OF THE INVENTION

In current laboratory environments, computers and, more specifically, laptop computers, are commonly used by both instructors and students while performing or demonstrating experiments. In addition, instructors and students must frequently find a place for books, papers, and equipment while performing experiments. Existing laptop stands can be beneficial for use in elevating laptops, books, papers, and electronic equipment, both for ergonomic reasons and for raising them above the surface of a laboratory table where spills are common. Ideally, such stands would occupy a minimum amount of table space to allow maximum room for experiment set up. Many laboratory tables, including teacher demonstration desks, have rod sockets for use with rod assemblies typically used for setting up experiments. The rod sockets can also be utilized to mount other devices, such as currently commercially available laptop stands, an example of which would be the “table-mounted laptop stand” sold by US Marker Board. A disadvantage of using a rod socket as a means to mount the currently available stands on a table, however, is that an available rod socket is taken up by the computer stand, thereby leaving fewer rod sockets available for experiment setup. It is desirable to provide a portable laboratory stand which could mount in a rod socket for stability and use minimal surface area but at the same time still allow for use of the rod socket in setting up experiments as well. The presently disclosed device solves this problem.

### SUMMARY OF THE INVENTION

We disclose a portable laboratory stand for supporting computers, electronic equipment, papers, books, or other items students or instructors might need to use in a classroom or while performing experiments which can be mounted in a rod socket without preventing use of the rod socket for other uses at the same time. The portable laboratory stand comprises a support surface having a raised lip on which one or more items may rest, a base having a peg for insertion into a rod socket and a receptacle for receiving a rod, and an elevation arm coupling the base to the support surface.

The portable laboratory stand of the current invention solves the problem of occupying an available rod socket by having a receptacle for receiving a rod within the base. In preferred embodiments of the invention, the support surface can have a restraining strap for restraining one or more items on the support surface. In addition, in a preferred embodiment, the elevation arm and support surface are oriented such that the top of the support surface does not vertically overlap the base so that a rod inserted into the base for performing experiments is not obstructed by the support surface.

### BRIEF DESCRIPTION OF THE DRAWINGS

A more complete appreciation of the present invention and many attendant advantages thereof will be readily understood by reference to the following detailed description of the invention when considered in connection with the accompanying drawings.

In the drawings, FIG. 1 illustrates a top plan view of the portable laboratory stand.

FIG. 2 illustrates one perspective view of the portable laboratory stand looking down from an angle to the right of center.

FIG. 3 illustrates a right side elevation view of the portable laboratory stand.

FIG. 4 illustrates a back elevation view of the portable laboratory stand.

FIG. 5 illustrates a perspective view of the portable laboratory stand looking up from below from an angle to the right of center.

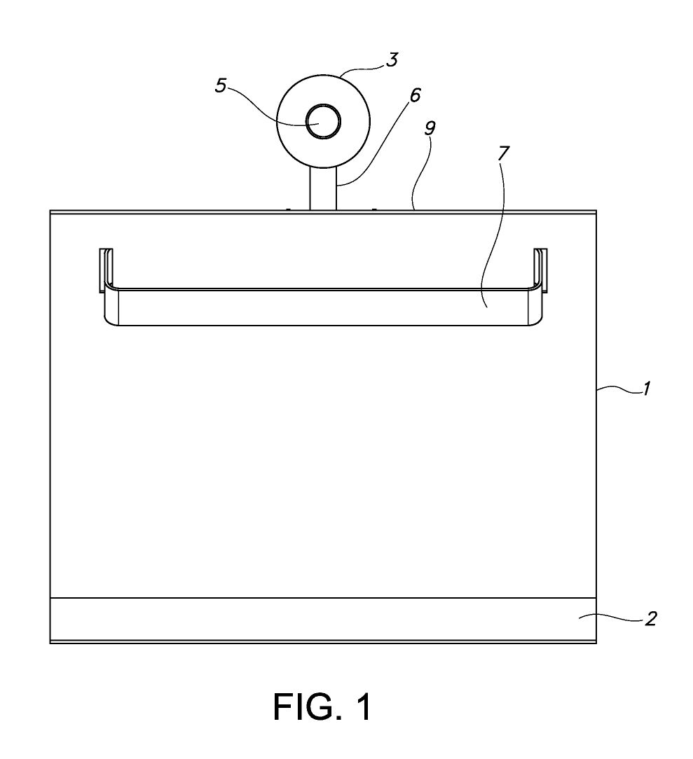

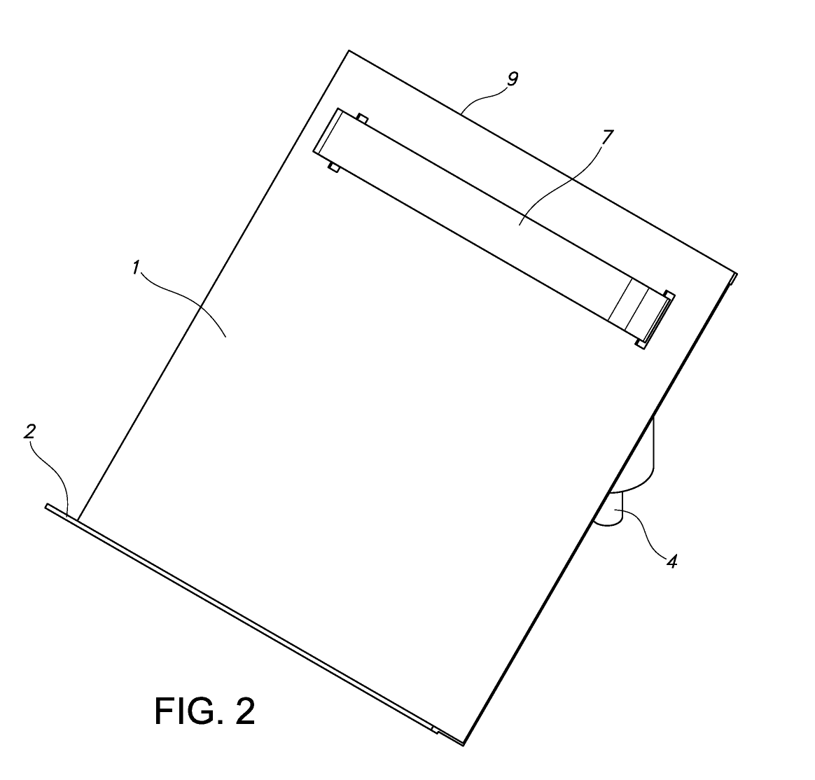

### DETAILED DESCRIPTION OF THE PREFERRED EMBODIMENT OF THE INVENTION

In reference to the drawings, there is shown a portable laboratory for use with the table having rod sockets. The support surface 1 is a flat platform which has a raised lip 2 upon which can sit one or more items such as a computer, papers, books, or a piece of electronic equipment. The support surface 1 is made in a preferred embodiment of epoxy or another type of phenolic chemical resistant surface, but it could also be made of other materials. Attached to the back of the support surface 1 is an elevation arm 6 which may be attached to the back of the support surface in a preferred embodiment of the invention by welding, although other attachment methods, such as glueing, use of brackets, or even flexible attachments, such as hinges, could be used. In a preferred embodiment of the invention the support surface also has a restraining strap 7. In the preferred embodiment of the invention shown in the figures, the restraining strap 7 passes through slots in the support surface 1 and connects on the back of the support surface 1 with a clasp 8. Although this is the method used in the shown preferred embodiment of the invention, it would be clear to one having ordinary skill in the art that alternative restraining straps could also be used such as elastic bands, straps going around the support surface instead of through it, and non-elastic bands having other methods of securing. Additionally, the clasp 8 could be replaced with an affixing hook-and-loop fastener. In the preferred embodiment of the invention shown in the figures, the support surface 1 is angled such that an item resting on the support surface can more easily rest on the support surface and be provided at a more comfortable viewing angle for the user.

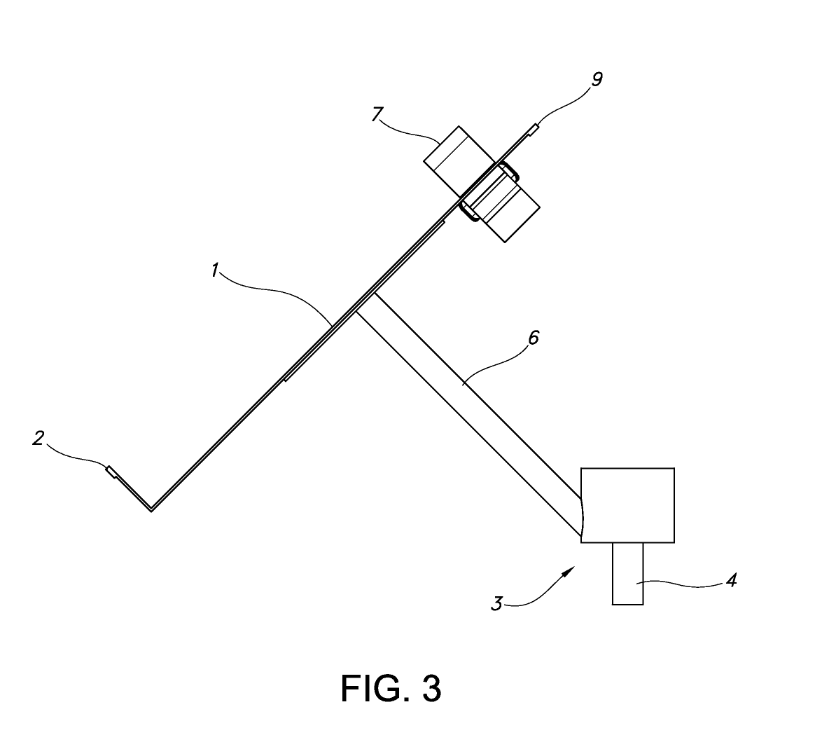

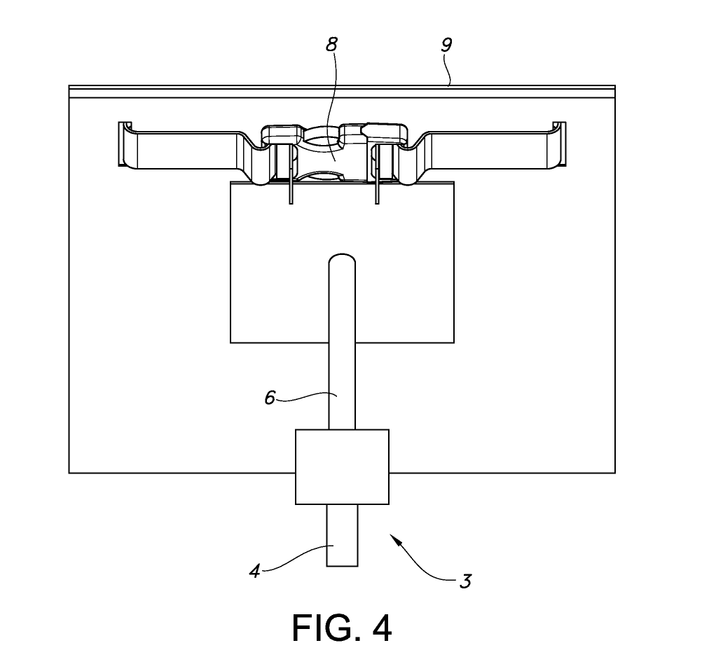

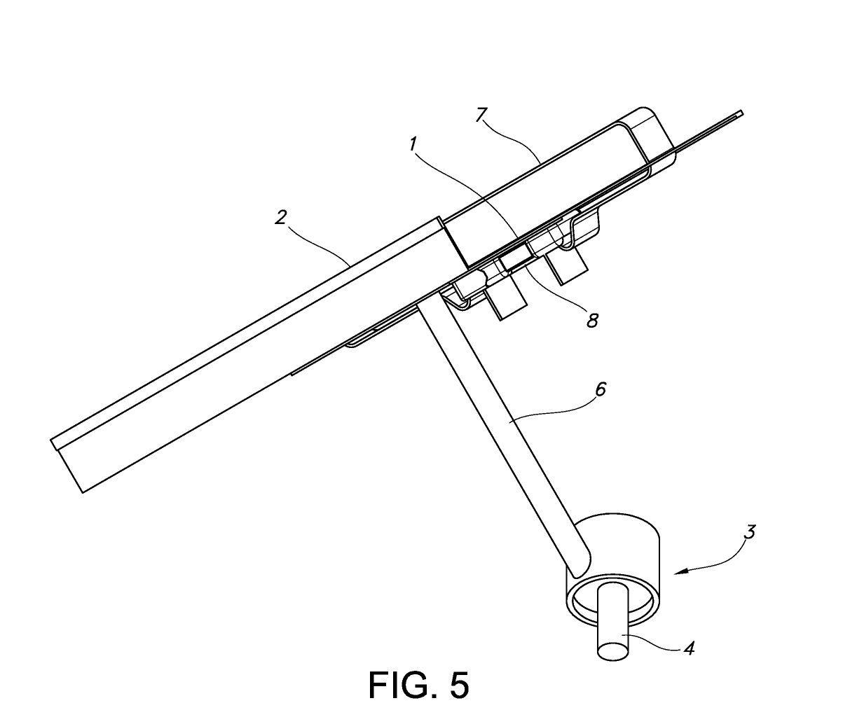

On the end of the elevation arm 6 opposite the support surface 1 is a base 3. In the preferred embodiment of the invention, the base 3 is of a cylindrical shape. The base 3 has a peg 4 extending downward from the base 3, the peg 4 being of appropriate size to be inserted into a rod socket, not shown, in a laboratory table or other surface upon which the stand would be used. When the peg 4 of the base 3 is inserted into a rod socket, a laboratory rod or other apparatus having a peg for support may be inserted into the receptacle 5 located on the upper side of the base 3. In a preferred embodiment the base 3, elevation arm 6, and support surface 1 are oriented at angles and sized such that the top 9 of the support surface 1 does not vertically overlap the receptacle 5 of the base 3. FIG. 1 shows this aspect of the invention, and FIG. 3 illustrates one possible orientation and relative sizing of the elements to achieve a lack of overlap. The orientation in this manner allows for an upright supporting rod, not shown, to be inserted into the receptacle 5 of the base 3 without interfering with the support surface 1. In a preferred embodiment of the invention, the support surface 1 is also oriented at an angle, neither perpendicular nor parallel, to the surface in which the portable laboratory stand is placed such that an item may easily rest on the support surface 1 and be held in place by gravity if a restraining strap 7 is not in use. While the drawings illustrate a preferred embodiment, the portable laboratory table can be of any width, height or depth and in any orientation to accommodate any items which would be supported on a table so long as the receptacle 5 of the base 3 remains accessible for use. It should be understood that the foregoing represents merely an exemplary embodiment of the disclosed device and that various changes and modifications can be made in the arrangements and details of construction of the elements described and shown herein without departing from the spirit and the scope of the present invention.

We claim:

1. A portable laboratory stand comprising:
a. A support surface having a raised lip;
b. A base, said base comprising a peg for insertion into a surface having rod sockets and a receptacle for receiving a second peg; and
c. An elevation arm coupling said base to said support surface.

2. The portable laboratory stand of claim 1 wherein said support surface includes a restraining strap.

3. The portable laboratory stand of claim 1 wherein said support surface is oriented at an angle such that it is neither perpendicular nor parallel to the surface on which it sits.

4. The portable laboratory stand of claim 2 wherein said restraining strap has a clasp for affixing said restraining strap.

5. The portable laboratory stand of claim 2 wherein said restraining strap is made of an elastic material.

6. The portable laboratory stand of clam 2 wherein said restraining strap is affixed via a hook-and-loop fastener.
